(19) United States
(12) Patent Application Publication
(10) Pub. No.: US 2008/0140591 A1
(43) Pub. Date: Jun. 12, 2008

(54) System and method for matching objects belonging to hierarchies

(75) Inventors: Deepak Agarwal, San Jose, CA (US); Deepayan Chakrabarti, Mountain View, CA (US); Vanja Josifovski, Los Gatos, CA (US); Sandeep Pandey, Santa Clara, CA (US)

Correspondence Address: Law Office of Robert O. Bolan, P.O. Box 36, Bellevue, WA, 98009, US

(73) Assignee: Yahoo! Inc., Sunnyvale, CA (US)

(21) Appl. No.: 11/637,524

(22) Filed: Dec. 12, 2006

(51) Int. Cl. G06F 15/18; G06F 7/20; G06F 17/30

(52) U.S. Cl. 706/12; 707/6; 707/E17.002; 707/E17.017

(57) ABSTRACT

An improved system and method for matching objects belonging to hierarchies is provided and an optimal matching between two feature spaces organized as taxonomies may be learned. The matching may be performed through a multi-level exploration of the hierarchical feature spaces by using multi-armed bandits where the arms of the bandit may be dependent due to the structure induced by the taxonomies. Upon the arrival of an object assigned to the first taxonomy, multi-armed bandits may be run at multiple levels of the taxonomies to select an object assigned to the second taxonomy. Then shrinkage estimation may be performed in a Bayesian framework to exploit dependencies among the arms by estimating payoff probabilities from a beta-binomial model to update payoff probabilities for matching objects from the taxonomies.

### FIELD OF THE INVENTION

The invention relates generally to computer systems, and more particularly to an improved system and method for matching objects belonging to hierarchies.

### BACKGROUND OF THE INVENTION

Content match is a common procedure performed for placing appropriate ads on web-pages. An objective of placing appropriate ads on web pages is to maximize total revenue from user clicks. In general, there may be many applications like content match where random elements of a set S arrive sequentially and are matched to elements in another set A. Every match may receive a stochastic reward with an unknown probability, and the goal is to maximize expected reward accumulated through time. Such applications include product recommendations for users visiting an e-commerce website like amazon.com based on visitors' demographics, previous purchase history, etc. In this case, set S may consist of unique visitors who are matched to a set A of products with an objective of maximizing total sales revenue.

When placing ads on pages in the context of content match, information that may be useful includes page attributes (e.g., page topic, content, etc.), ad attributes (e.g., theme of the ad, anchor text, landing page, etc.), and other contextual information (user demographics, their recent behavior, etc.). Assuming both pages and ads have been mapped to high dimensional feature spaces and each click on an ad earns some revenue, an online advertising service would want to be able to map points in a feature space of page attributes to another feature space of ad attributes to maximize total expected revenue. This may involve exploring different ads to find good ones more effectively and exploiting the ads that are currently known to have good click rates. However, designing effective policies for matching ads to web pages in this context is a daunting task for several reasons. First of all, the data may be sparse. The feature spaces are extremely large (billions of pages, millions of ads with a lot of diversity and heterogeneity in both pages and ads) and the data extremely sparse since only a few interactions may be observed for a majority of page-ad feature pairs. Second, the click-through rate (CTR hereafter) defined as the number of clicks per impression (number of showings) for a majority of page-ad feature pairs are small, leading to increased learning time. Third, exploration for effective ads needs to be accomplished with good short term performance. Business considerations often constrain learning CTR values. A policy should learn CTR values in an online setting for a large majority of page-ad feature pairs. This is important since the available inventory is finite. For instance, there may be some best ads that run out for certain pages and there may be an opportunity to increase overall revenue by understanding alternative matchings. Accordingly, CTR values need to be learned within a reasonable time horizon and without incurring large drops in revenue, even in the short run. A policy for matching ads to web pages that does excessive exploration may result in providing gradual but slow revenue growth before it converges to the optimal matching. On the other hand, a policy that merely tries to achieve optimality quickly may incur an unnecessarily large revenue loss during the learning period. An ideal policy would converge rapidly to the optimal matching while having a smooth revenue profile.

To deal with these difficulties, existing content match techniques may reduce dimensionality of both web page and ad features by assuming CTRs are simple functions of both web page and ad features. Although functional, the assumption of linearity and additivity of page and ad features is often violated in content matching and leads to CTR estimates that are biased. In fact, interactions among features typically occurs and are extremely important for learning CTRs. What is needed is a way to match objects in one set arriving sequentially with objects in another set by using features of the objects. Such a system and method should be able to match objects in order to maximize expected reward accumulated through time where the sets are large and sparse.

### SUMMARY OF THE INVENTION

Briefly, the present invention may provide a system and method for matching objects belonging to hierarchies. In various embodiments, a server may include an operably coupled matching engine that may provide services for matching objects classified in one taxonomy with objects classified in another taxonomy by running multi-armed bandits for multiple levels of the taxonomies in order to maximize an overall payoff. The matching engine may include an operably coupled index generator for generating indexes for accessing multiple taxonomies and payoff probabilities, a multi-armed bandit engine for running bandits to determine payoff probabilities for matching an object from a taxonomy with objects from another taxonomy, and a shrinkage estimator for performing shrinkage estimation of the payoff probabilities for matched objects from the taxonomies.

The present invention may provide a framework for learning an optimal matching between two feature spaces that may be organized as taxonomies using multi-armed bandits. In an embodiment, a content match application may use the present invention for placing advertisements on web pages to maximize total revenue from user clicks. In general, an allocation step may be performed when a page class arrives by matching it to an appropriate ad class based on the current estimates of the CTR values. Then an estimation step may be performed to estimate CTR values after taking into account the outcomes of previous allocations.

In particular, a taxonomy of web page classes may be partitioned into web page class groups and a taxonomy of ad classes may be partitioned into ad class groups. A multi-level policy may run bandits at two levels of the taxonomies: first, a bandit may be run on the ad class groups corresponding to a page class group to select an add class group, and then a bandit may be run on the ad classes of the selected ad class group to select an ad class. After the arriving page class may be allocated to an ad class resulting in a click or no-click, then CTR values may be estimated for page-ad pairs of the group. The CTR estimates may be derived from a beta-binomial model, if the beta-binomial model may be a good fit for the page-ad group. If the beta-binomial model may not be a good fit, maximum likelihood estimates may be used instead.

Accordingly, the present invention may be used to learn an optimal matching between two feature spaces that may be organized as taxonomies. The matching may be performed through a multi-level exploration of the hierarchical feature spaces by using multi-armed bandits where the arms of the bandit may be dependent due to the structure induced by the taxonomies. Advantageously, the present invention may use the taxonomy structures and may perform shrinkage estimation in a Bayesian framework to exploit dependencies among the arms, thereby enhancing exploration without losing efficiency on short term exploitation. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for matching objects belonging to hierarchies, in accordance with an aspect of the present invention;

FIG. 3 is a flowchart for generally representing the steps undertaken in one embodiment for matching objects belonging to hierarchies by learning an optimal matching between two feature spaces that may be organized as taxonomies, in accordance with an aspect of the present invention;

FIG. 4 is a flowchart for generally representing the steps undertaken in one embodiment for matching web pages classified in one taxonomy with advertisements classified in another taxonomy by running multi-armed bandits for multiple levels of the taxonomies in order to maximize an overall payoff, in accordance with an aspect of the present invention;

FIG. 5 is a flowchart for generally representing the steps undertaken in one embodiment for creating indexed storage for recording estimated CTRs for matched nodes from the taxonomies, in accordance with an aspect of the present invention;

FIG. 6 is a flowchart for generally representing the steps undertaken in one embodiment for matching the node of the first taxonomy representing a web page class with a node of the second taxonomy representing an ad class by running multi-armed bandits for multiple levels of the taxonomies, in accordance with an aspect of the present invention; and

FIG. 7 is a flowchart for generally representing the steps undertaken in one embodiment for fitting a beta-binomial model to a group of CTR values that include the CTR value of the matched nodes, in accordance with an aspect of the present invention.

### DETAILED DESCRIPTION

### Exemplary Operating Environment

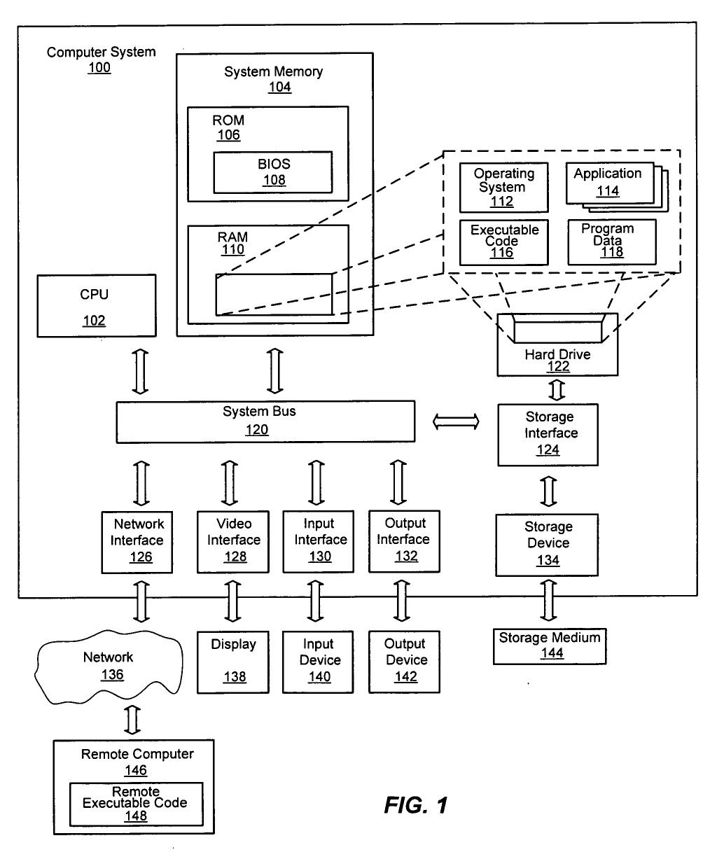

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Matching Objects Belonging to Hierarchies

The present invention is generally directed towards a system and method for matching objects belonging to hierarchies and may be used to learn an optimal matching between two feature spaces that may be organized as taxonomies. The matching may be performed by using multi-armed bandits where the arms of the bandit may be dependent due to the structure induced by the taxonomies. A multi-stage hierarchical allocation may then be employed that may improve exploration of the feature spaces using multi-armed bandits. More particularly, the present invention may use the taxonomy structures and may perform shrinkage estimation in a Bayesian framework to exploit dependencies among the arms, thereby enhancing exploration without losing efficiency on short term exploitation.

As will be seen, the framework of the present invention may be used for many online applications including content match applications for placing advertisements on web pages to maximize total revenue from user clicks. As will be understood, the various block diagrams, flow charts and scenarios described herein are only examples, and there are many other scenarios to which the present invention will apply.

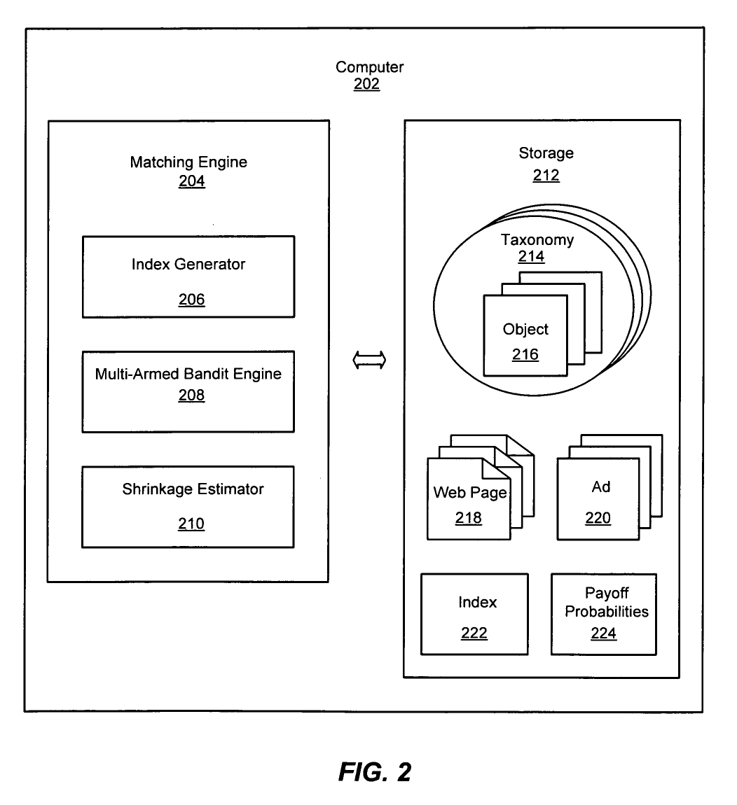

Turning to FIG. 2 of the drawings, there is shown a block diagram generally representing an exemplary architecture of system components for matching objects belonging to hierarchies. Those skilled in the art will appreciate that the functionality implemented within the blocks illustrated in the diagram may be implemented as separate components or the functionality of several or all of the blocks may be implemented within a single component. For example, the functionality for the multi-armed bandit engine 208 may be included in the same component as the index generator 206. Or the functionality of the shrinkage estimator 210 may be implemented as a separate component from the matching engine 204. Moreover, those skilled in the art will appreciate that the functionality implemented within the blocks illustrated in the diagram may be executed on a single computer or distributed across a plurality of computers for execution.

In various embodiments, a computer 202, such as computer system 100 of FIG. 1, may include a matching engine 204 operably coupled to storage 212. In general, the matching engine 204 may be any type of executable software code such as a kernel component, an application program, a linked library, an object with methods, and so forth. The storage 214 may be any type of computer-readable media and may store taxonomies 214 of objects 216 such as web pages 218, or links to web pages such as URLs, advertisements such as ads 220, an index 222 for accessing the taxonomy classes, and payoff probabilities 224. For instance, a content matching application may use the present invention to match advertisements classified in a taxonomy of advertisements with web pages classified in a taxonomy of web pages. A web page may be any information that may be addressable by a URL, including a document, an image, audio, and so forth. In the context of a content matching application placing ads on web pages, the payoff probabilities 224 may represent CTR values of page-ad pairs.

In general, the matching engine 204 may provide services for matching objects classified in one taxonomy with objects classified in another taxonomy by running multi-armed bandits for multiple levels of the taxonomies in order to maximize an overall payoff. The matching engine 204 may include an index generator 206 for generating one or more indexes 222 for accessing multiple taxonomies 214 and payoff probabilities 224, a multi-armed bandit engine for running bandits to determine payoff probabilities for matching an object from a taxonomy with objects from another taxonomy, and a shrinkage estimator 210 for performing shrinkage estimation of the payoff probabilities for matched objects from the taxonomies. Each of these modules may also be any type of executable software code such as a kernel component, an application program, a linked library, an object with methods, or other type of executable software code.

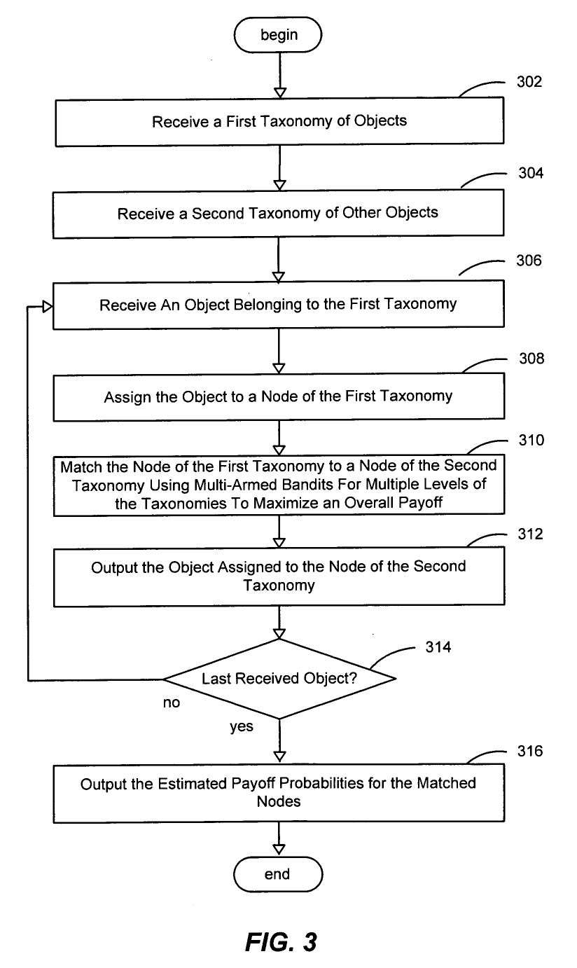

FIG. 3 presents a flowchart for generally representing the steps undertaken in one embodiment for matching objects belonging to hierarchies by learning an optimal matching between two feature spaces that may be organized as taxonomies. A first taxonomy of objects may be received at step 302 and a second taxonomy of other objects may be received at step 304. At step 306, an object belonging to the first taxonomy may be received. The object may be assigned to a node in the first taxonomy at step 308. The node of the first taxonomy may be matched with a node of the second taxonomy at step 310 by running multi-armed bandit for multiple levels of the taxonomies to maximize overall payoffs of matching nodes of the taxonomies. The object assigned to the node of the second taxonomy may then be output at step 312. At step 314, it may be determined whether the object received was the last object to be matched. If not, then processing may continue at step 306. Otherwise, the estimated payoff probabilities of matching nodes of the taxonomies may be output at step 316 and processing may be finished for matching objects belonging to hierarchies by learning an optimal matching between two feature spaces that may be organized as taxonomies.

There are many applications which may use the present invention for matching objects classified in one taxonomy with objects classified in another taxonomy. For example, applications like product recommendation or content match for placing appropriate ads on web pages may use the present invention. In the case of an application for product recommendation, unique visitors arriving sequentially to a website may be classified in a taxonomy of users and may be matched to products classified in a taxonomy of products with the objective of maximizing total sales revenue. Similarly, for an application like content match, web pages arriving sequentially may be classified in a taxonomy of web pages and may be matched to ads classified in a taxonomy of ads with the objective of maximizing total revenue from user clicks. Those skilled in the art will appreciate that the techniques of the present invention are quite general, and will also apply for other applications where random objects of a set may arrive sequentially, may be classified in a taxonomy, and may be matched to other objects classified in another taxonomy.

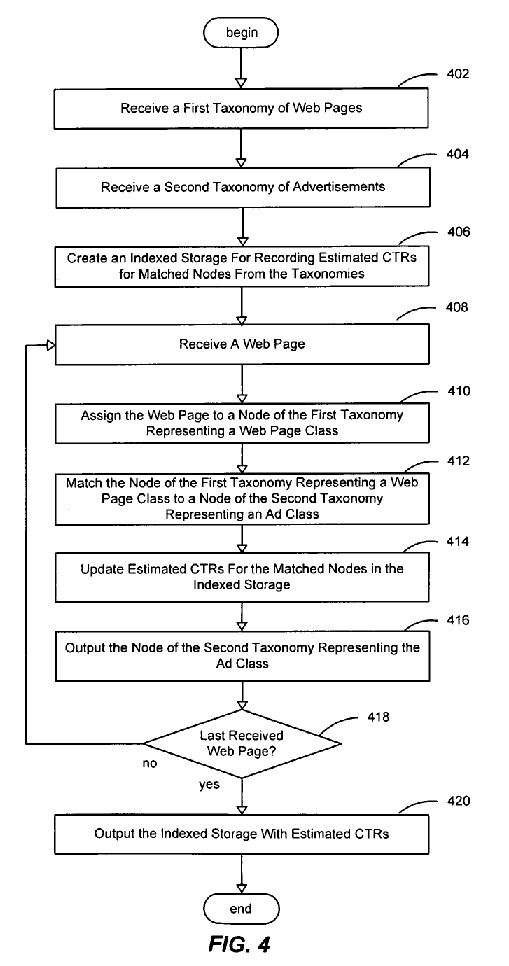

FIG. 4 presents a flowchart for generally representing the steps undertaken in one embodiment for matching web pages classified in one taxonomy with advertisements classified in another taxonomy by running multi-armed bandits for multiple levels of the taxonomies in order to maximize an overall payoff. A first taxonomy of web pages may be received at step 402 and a second taxonomy of advertisements may be received at step 404. For instance, arriving web pages may be classified in a web page taxonomy and ads may be previously classified in an ad taxonomy. In an embodiment, levels of the taxonomies, such as the two lowest successive levels of the taxonomies, may be used for exploring payoff probabilities for matching web pages with ads. At step 406, an indexed storage may be created for recording estimates CTRs for matched nodes from the taxonomies.

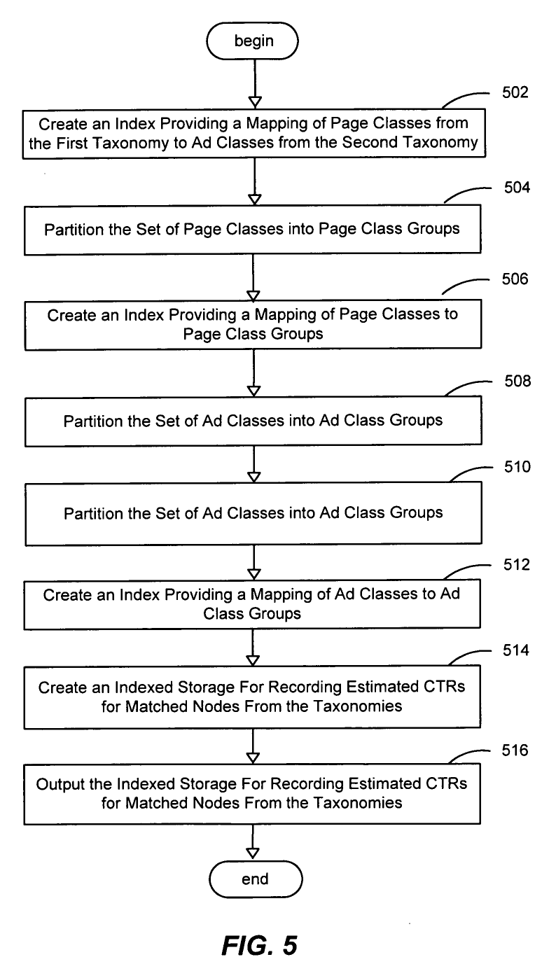

FIG. 5 presents a flowchart for generally representing the steps undertaken in one embodiment for creating indexed storage for recording estimated CTRs for matched nodes from the taxonomies. An index providing a mapping of web page classes from a first taxonomy to advertisement classes from a second taxonomy may be created at step 502. For example, consider the lowest level nodes of the web page taxonomy to represent web page classes which may be denoted by S={s₁, . . . , Sᵤ} and the lowest level nodes of the ad taxonomy to represent ad classes which may be denoted by A={a₁, . . . , aᵥ}. The index may be implemented using one or more arrays in an embodiment. At step 504, the set of web page classes may be partitioned into web page class groups. For instance, web page classes that may be children of the same parent node from an upper level of the taxonomy may constitute a page class group in an embodiment. At step 506, an index providing a mapping from web page classes to web page class groups may be created. At step 508, the set of advertisement classes may be partitioned into advertisement class groups. For example, ad classes that may be children of the same parent node from an upper level of the taxonomy may constitute an ad class group in an embodiment. At step 510, an index providing a mapping from advertisement classes to advertisement class groups may be created. At step 512, indexed storage providing a mapping from page classes to advertisement classes may be created for recording estimated CTRs for matched nodes of the taxonomies. For example, the payoff probabilities 224 illustrated in FIG. 2 may be indexed storage providing a mapping of pairs of page class and advertisement class for recording estimated CTRs for matched nodes of the taxonomies. In an embodiment, the indexed storage may be implemented using one or more arrays that may be conceptually represented by a page-ad connection matrix that may be defined by C=S×A where each cell of the connection matrix may represent a CTR value for the corresponding pair of page class and ad-class. At step 514, indexed storage for recording estimated CTRs for matched nodes of the taxonomies may be output and processing may be finished for creating indexed storage for recording estimates CTRs for matched nodes from the taxonomies.

Returning to FIG. 4, a web page belonging to the first taxonomy may then be received at step 408. The web page may be assigned at step 410 to a node in the first taxonomy representing a web page class. The node of the first taxonomy representing a web page class may be matched at step 412 with a node of the second taxonomy representing an ad class by running multi-armed bandits for multiple levels of the taxonomies to maximize overall payoffs of matching nodes of the taxonomies. Thus, as arriving web pages may be classified and matched to ads, an optimal matching of web page classes to ad classes may be learned in order to maximize the expected total number of clicks. At step 414, the estimated CTRs for matched nodes of the taxonomies may be updated in the payoff probabilities storage. Additional estimated CTRS may also be updated. For example, a group of estimated CTRS that may include the matched nodes may also be updated. The node of the second taxonomy representing the ad class may then be output at step 416. At step 418, it may be determined whether the web page received was the last web page to be matched. If not, then processing may continue at step 408. Otherwise, the indexed storage with estimated CTRS of matching nodes of the taxonomies may be output at step 418 and processing may be finished for matching web pages classified in one taxonomy with advertisements classified in another taxonomy by running multi-armed bandits for multiple levels of the taxonomies in order to maximize an overall payoff.

In an embodiment, an optimal matching of web page classes to ad classes may be learned using multi-armed bandits. For each page class, a v-armed bandit may be created, where there may be an arm for each of the ad classes so that v=|A| and the payoff probabilities may be derived from the CTR values. Thus, there may be u-bandits that may arise simultaneously, where u=|S|. In general, those skilled in the art may appreciate that a multi-armed bandit may derive its name from an imagined slot machine with k≧2 arms. The i^{th} arm may have a payoff probability pᵢ which may be unknown. When arm i may be pulled, a player may win a unit reward with payoff probability pᵢ. The objective is to construct N successive pulls of the slot machines to maximize the total expected reward. This gives rise to a dilemma between choosing to explore unknown payoff probabilities by gathering information on the unknown payoff probabilities and exploiting the best known rewards by sampling arms with the best payoff probabilities empirically estimated so far. A bandit policy or allocation rule may provide an adaptive sampling process that provides a mechanism to select an arm at any given time instant based on all previous pulls and their outcomes. A popular metric to measure performance of a policy is called regret, which is the difference between the expected reward obtained by playing the best arm and the expected reward given by the policy under consideration. A large body of bandit literature has considered the problem of constructing policies that achieve tight upper bounds on regret as a function of the time horizon N (total number of pulls) for all possible values of the payoff probabilities. The seminal work of T. Lai and H. Robbins, Asyymptotically Efficient Adaptive Allocation Rules, Advances in Applied Mathematics, 6:4-22, 1985, showed how to construct policies for which the regret is of O(log N) asymptotically for all values of payoff probabilities. They further proved and constructed policies that achieve asymptotic lower bounds of log N for the regret. Subsequent work has constructed policies that are simpler and achieve the logarithmic bound uniformly rather than asymptotically. (See for example, P. Auer, N. Cesa-Bianchi, and P. Fischer, Finite-time Analysis of the Multiarmed Bandit Problem, Machine Learning, 47:235-256, 2002 and the references therein.) The main idea in all these policies is to associate with each arm a priority function which is a sum of the current empirical payoff probability estimate plus a factor that depends on the estimated variability. By sampling an arm with the highest priority at any point in time, arms with little information may be explored and arms which are known to be good based on accumulated empirical evidence may be exploited. As N may increase, the sampling variability may be reduced, resulting in convergence to an optimal arm.

It is important to note that in constructing multi-armed bandits for learning the optimal matching of web page classes to ad classes, the v arms of each bandit created for a page class, and the bandits themselves, may not be independent of each other since S and A may be partitioned into page-class groups and ad-class groups. In particular, the arms in the same group may be likely to have similar payoff probabilities. By exploiting this structure, bandit policies may be constructed that may be optimal asymptotically and yet may achieve better performance in the short run.

Consider, for instance, the suffix ij to denote a pair corresponding to a page class sᵢ and an ad class aⱼ. Also consider πᵢ and kⱼ to denote group IDs of a page-class group and an ad-class group respectively. B_{π}_{ᵢ}ₖ_{ⱼ} may then denote the group or block that contains the ij^{th} pair corresponding to page class sᵢ and ad class aⱼ. In particular, B_{IJ} denotes the group or block containing pairs of a page class and an ad class obtained by taking the cross-product of page classes in page class group I and ad classes in ad class group J. Consider k₁ and k₂ to denote the number of page class groups and ad class groups respectively. A set of groups or blocks may then be denoted as B_{I}+∪_{J=1}^{k}^{₂} or B_{+J}=∪_{I=1}^{k}B_{IJ}. For example, in an embodiment where a page-ad connection matrix C may be constructed, B₁₊=∪_{J=1}^{k}^{₂}B_{IJ} may represent a row of blocks and B_{+J}=∪_{I=1}^{k}^{₁}B_{IJ} may represent a column of blocks in the connection matrix C. A row for page class sᵢ in connection matrix C intersecting the block B₉₀_{ᵢ}_{J} may be denoted by R(i;B_{π}_{ᵢ}_{J}), and a row for page class sᵢ intersecting a row of blocks B₁₊in connection matrix C may be denoted by R(i;+)=∪_{J=1}^{ki}^{₂}R(i;B_{π}_{ᵢ}_{J}).

For any set U of pairs corresponding to a page class sᵢ and an ad class aⱼ, consider p_{U}, S_{U} and N_{U} to denote the true CTR, number of clicks and sample size (number of impressions or pulls) after the n^{th} allocation may have been made. Also, consider \hat{p}_{U}=S_{U}/N_{U} to denote the maximum likelihood estimate of p_{U} and

$${CV}_{U} = \sqrt{\frac{1 - {\hat{p}}_{U}}{{N}_{U} {\hat{p}}_{U}}}$$

to denote an estimated coefficient of variation for U (assuming a binomial distribution with uniform CTR for pairs of U). Also consider CV_{π}_{ᵢ}₍ᵣ₎ to denote an estimated coefficient of variation with rank r among blocks B_{π}_{ᵢ}_{J}, where J=1, . . . ,k₂.

The feature spaces for matching web pages to ads may be extremely large. For instance, there may be billions of pages and millions of ads. In practice, the data for CTRs may be extremely sparse since only a few interactions may be observed for a majority of page-ad feature pairs. However, a small fraction of page-ad pairs may have relatively higher CTRs. This may provide an ideal situation for improving overall estimation accuracy by using Bayesian smoothing or shrinkage estimation. The method assumes that the CTR values, pᵢⱼ, may be drawn from a prior distribution F({pᵢⱼ};θ) that depends on the parameter vector θ. (to be estimated from data). The posterior distribution of pᵢⱼ values may provide “smooth” estimates with better mean squared error compared to a simple scheme like maximum likelihood estimation under the assumption of independence. However, the degree of smoothing may depend on the choice of F. Advantageously, the presence of groups or blocks B_{IJ} derived from the taxonomies enables a separate prior distribution to be estimated for each group or block. In an embodiment, smoothing across groups or blocks may be introduced through hyperpriors on group or block priors.

Since better estimation may depend on being able to estimate prior distributions for each group or block, a multi-stage allocation strategy may be employed that runs a bandit at the group level on the k₂ distinct sets B_{π}_{ᵢ}_{J} for a given page class sᵢ to select an individual group or block with ad class group J*, followed by running a bandit for page-ad pairs for a given page class in the group B_{π}_{ᵢ}_{J}* to select a good ad class in J*. on R(i;B_{π}_{ᵢ}_{J}*) for the given page class, where J* may correspond to the group or block selected, to select an ad class. The group level bandit ensures that each group or block may be explored often enough to estimate its prior distribution quickly. However, since it aggregates clicks over page classes of the group or block, it has the potential problem of missing out on good pairs that include certain page classes in the long run. To circumvent this, the multi-stage allocation strategy may provide a mechanism to switch from running a group level bandit to running a bandit for page-ad pairs for a given page class in the group B_{π}_{ᵢ}_{J}* to select a good ad class in J* at some point. The switch may occur by evaluating a statistical criterion that may ensure that the policy asymptotically converges to an optimal matching.

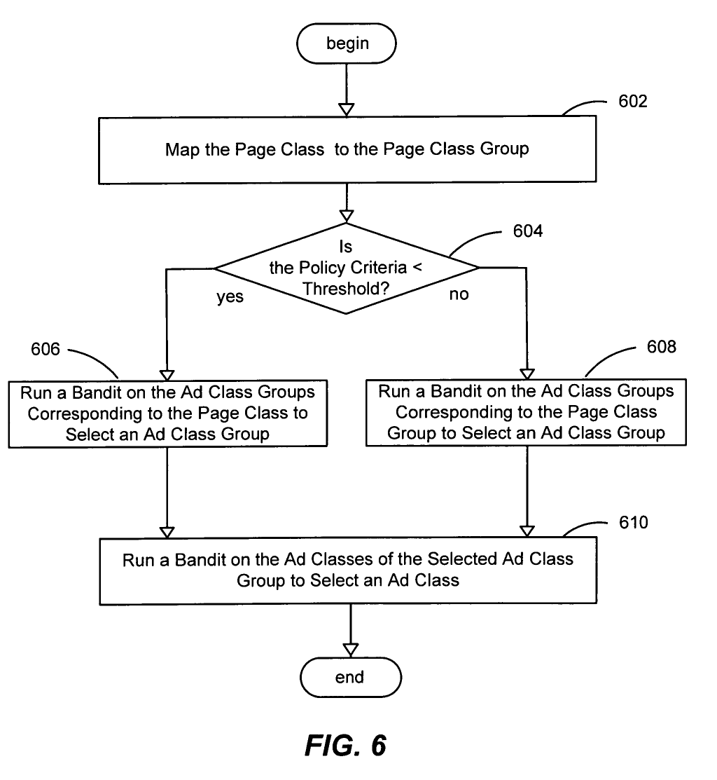

FIG. 6 presents a flowchart for generally representing the steps undertaken in one embodiment for matching the node of the first taxonomy representing a web page class with a node of the second taxonomy representing an ad class by running multi-armed bandits for multiple levels of the taxonomies. In general, the multi-stage allocation policy may perform an allocation step when the n^{th} page class arrives by matching it to an appropriate ad class based on the current estimates of the CTR values. Then the multi-stage allocation policy may perform an estimation step to estimate CTR values after taking into account the outcomes of previous allocations.

Given an arriving page-class sᵢ, the multi-level policy may run bandits at multiple levels of the taxonomies during the allocation step. For example, in an embodiment the multi-level policy may run bandits at two levels of the taxonomies: first, a bandit may be run over groups or blocks B_{π}_{ᵢ}_{J}, where J=1, . . . ,k₂ to select a good ad class group J*, and then a bandit may be run for page-ad pairs for a given page class in the group B_{π}_{ᵢ}_{J}* to select a good ad class in J*. Intuitively, the first stage may quickly identify blocks with good CTR values, since there may be only k₂ of these for each sᵢ. This helps in focusing the search for good pairs early on towards the good groups or blocks of pairs. Also, it may ensure that no group or block may be neglected and that prior distributions for groups or blocks, critical for the estimation step, may be computed quickly. However, if there may be a good pair for a page class si which may arrives infrequently, the group or block estimates may be overwhelmed by page classes that may have poor CTRS in the same group or block. To circumvent this, the first stage of the multi-level policy may switch from running a group level bandit to running a bandit for page-ad pairs, if a statistical criterion based on CV_{π}_{ᵢ}₍ᵣ₎ may be less than a threshold, τ.

At step 602, the web page may be mapped to a web page class group. In an embodiment, the node of the first taxonomy assigned the web page may be mapped to a group of nodes of the first taxonomy representing a web page class group that includes the web page class assigned the web page. At step 604, it may be determined whether a policy criteria may be less than a threshold. In an embodiment, a statistical criterion based on CV_{π}_{ᵢ}₍ᵣ₎ may be compared to a threshold, τ. If so, then a bandit may be run on the ad class groups corresponding to the page class at step 606 to select an add class group and processing may continue at step 610. Otherwise, a bandit may be run on the ad class groups corresponding to the page class group at step 608 to select an ad class group and processing may continue at step 610. In an embodiment, an ad class group may be selected using the following multi-level policy for the first stage at steps 606 and 608:

$${J}^{*} = \{ \begin{matrix} arg {max}_{J ∈ \{ 1 , … , {k}_{2} \}} ( {\hat{p}}_{R ( i ; B {π}_{i} J )} + \sqrt{\frac{2 ln {N}_{R ( i ; + )}}{{N}_{R ( i ; B {π}_{i} J )}}} ) & if {CV}_{{π}_{i} ( r )} \leq τ \\ arg {max}_{J ∈ \{ 1 , … , {k}_{2} \}} ( {\hat{p}}_{B {π}_{i} J} + \sqrt{\frac{2 ln {N}_{B ( {π}_{i} , + )}}{{N}_{B {π}_{i} J}}} ) & otherwise .\end{matrix}$$

A bandit may then be run on the ad classes of the selected ad class group at step 610 to select an ad class. In an embodiment, an add class may be selected using the following multi-level policy for the second stage at step 610:

$${k}^{*} = arg {max}_{k ∈ R ( i ; {B}_{{π}_{i} {J}^{*}} )} ( {\tilde{p}}_{ik} + \sqrt{\frac{2 ln ( {N}_{R ( i ; {B}_{{iJ}^{*}} )} + {γ}_{R ( i ; {B}_{{iJ}^{*}} )} )}{( {N}_{ik} + {γ}_{ik} )}} ) , where$$

\hat{p}ᵢₖ may be the estimated CTR based on the model in B_{π}_{ᵢ}_{J}*. After selecting an ad class, processing may be finished for matching the node of the first taxonomy representing a web page class with a node of the second taxonomy representing an ad class by running multi-armed bandits for multiple levels of the taxonomies.

The multi-level policy may use any multi-armed bandit as a subroutine. For instance, the UCB1 scheme described by P. Auer, N. Cesa-Bianchi, and P. Fischer (see Finite-time Analysis of the Multiarmed Bandit Problem, Machine Learning, 47:235-256, 2002) may be used in an embodiment. The optimal ad class k* corresponding to a page class sᵢ may be determined by the following function:

$${k}^{*} = arg {max}_{k ∈ R ( i ; + )} ( {\tilde{p}}_{ik} + \sqrt{\frac{2 ln ( {N}_{R ( i ; + )} )}{{N}_{ik}}} ) .$$

The priorities of the arms may be obtained by superimposing estimated CTRs with a component that denotes the size of an upper one-sided confidence interval containing the true CTR with overwhelming probability. The first component may help in exploiting good ad classes while the second component supports exploration. This policy may have a logarithmic regret uniformly in the number of pulls.

After the n^{th} arriving page class may be allocated to an ad class aⱼ resulting in a click or no-click, then the multi-stage allocation policy may perform an estimation step to estimate CTR values for pairs of the group or block B_{π}_{ᵢ}ₖ_{ⱼ}. A beta-binomial model may be fit to the block, and, if the fit may be satisfactory, the beta-binomial estimates may be used for the CTRs of the pairs in the group or block B_{π}_{ᵢ}ₖ_{ⱼ}, according to the function E(p|S,γ,α)=wα+(1−w)(S/N). However, if the beta-binomial does not provide a good fit, the maximum likelihood estimates may be used instead.

In performing the estimation step, it may be assumed that the number of clicks Sᵢⱼ are binomially distributed such that Sᵢⱼ|pᵢⱼ˜Bin(Nᵢⱼ,pᵢⱼ)(X|Y), where X|Y may denote the conditional distribution of X given Y and where Nᵢⱼ may represent the total number of observations (henceforth, sample size) of pair sᵢaⱼ, and pᵢⱼ may represent the true CTR of pair sᵢaⱼ. Further assume that all Sᵢⱼs are conditionally independent given pᵢⱼs. If the Nᵢⱼs may be large, the true CTRs may be estimated for pairs using maximum likelihood estimators (MLE) \hat{p}ᵢⱼ=Sᵢⱼ/Nᵢⱼ. Although some pairs of page class and ad class may have higher CTRs (e.g., ski ads may have higher CTRS with pages about winter sports), a majority of pairs of page class and ad class may have low CTRs and hence may receive relatively fewer pulls by the bandit policy, leading to small sample sizes Nᵢⱼ used to estimate the CTRs of the pairs of page class and ad class. Because a large sample size may imply better information about a CTR of a pair of page class and ad class, a shrinkage estimator may be applied in which the estimate of a particular pair of page class and ad class may be a convex combination of a global estimator and an estimator (usually the MLE) exclusively derived from the information of sample size. If the MLE may be based on a large sample size, more weight may be given to the estimator; otherwise, more weight may be given to the global estimator, if the MLE may be based on a small sample size.

An empirical Bayes approach based on a beta-binomial model may provide an attractive way to accomplish shrinkage estimation. In particular, {pᵢⱼ:ijεB_{IJ}} may be drawn from a beta distribution with parameters α_{B}_{_{IJ}} (mean) and γ_{B}_{_{IJ}} (effective sample size), which in turn may induce independent beta-binomial models for each group or block. This distribution may naturally arise in a hierarchical Bayesian context as follows. For a single data point {S,N}, if S|p˜Bin(N,p) and p˜Beta(γα,γ(1−αa)), the marginal distribution of S may have a closed form expression and may be a beta-binomial distribution. By Bayes theorem, p|S˜Beta(γα+S, γ(1−α)+N−S) and hence the posterior mean may be given by E(p|S,γ,α)=wα+(1−w)(S/N), where w=γ/(γ+N). Note that w→0 if and only if γ/N→0 and may correspond to the case of “no shrinkage”. For small N, w may be close to 1, shrinking the posterior mean towards the global mean α. Thus, γ may determine the weight attached to the prior mean a and hence the amount of shrinkage. Additionally, γ may also be interpreted as the effective sample size available a-priori. This may become evident from the density of the beta distribution which may be proportional to a binomial density with γα−1 successes and γ(1−α)−1 failures. In practice, the parameters of the beta prior may not be known and may have to be estimated from the data. However, this may not be possible unless there may be a set of data points {Sₖ,Nₖ}k such that Sₖ|pₖ˜Bin(Nₖ,pₖ) and pₖ˜Beta(γα,γ(1−α)). Then α and γ may be estimated based on a beta-binomial likelihood using maximum likelihood and hence may provide estimates of the posterior distribution of pₖs In fact, maximum likelihood estimation of α and γ have been well studied and it may be well known that the estimation of α may be more stable compared to that of γ. In particular, estimation of γ may become unstable if γ>3000.

It may be instructive to look at the mean and variance of Sₖ after marginalizing over pₖ. The mean may be represented by E(Sₖ)=Nₖα and the variance of Sₖ may be represented by Var(Sₖ)=Nₖα(1−α)[1+(Nₖ−1)/(γ+1)]. When compared to the variance of a binomial model with parameters Nₖ and α, the variance term in the function Var(Sₖ)=Nₖα(1−α)[1+(Nₖ−1)/(γ+1)] may involve an additional factor which is a function of γ. This may account for the extra-binomial variation or over dispersion which may be present in the data of CTRs. For additional details of a beta-binomial distribution, see M. J. Kahn and A. E. Raftery, Discharge Rates of Medicare Stroke Patients To Skilled Nursing Facilities: Bayesian Logistic Regression With Unobserved Heterogeneity, Journal of the American Statistical Association, 91:29-41, 1996.

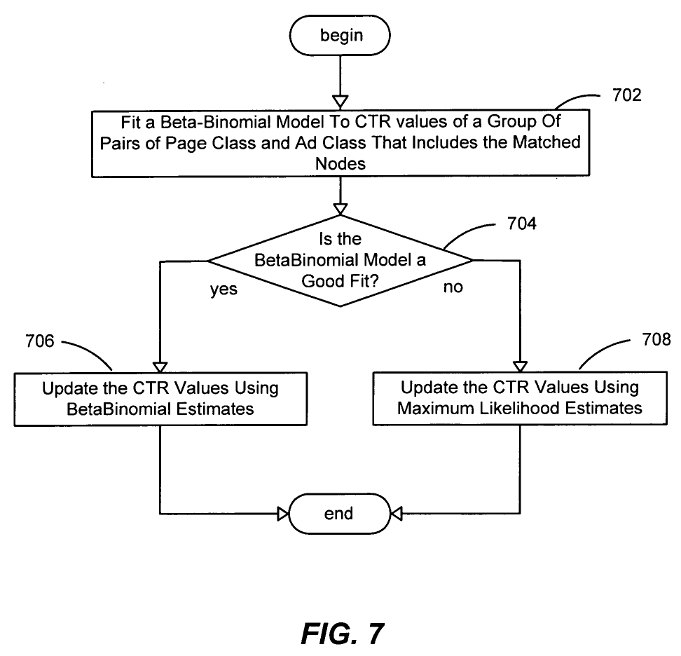

FIG. 7 presents a flowchart for generally representing the steps undertaken in one embodiment for fitting a beta-binomial model to a group of CTR values that include the CTR value of the matched nodes. At step 702, a beta-binomial model may be fit to a group of CTR values that include the CTR value of the matched nodes. It may be determined at step 704 whether the beta-binomial model may be a good fit. If so, then the group of CTR values may be updated using the beta-binomial estimates. Otherwise, the group of CTR values may be updated using maximum likelihood estimates and processing may be finished for fitting a beta-binomial model to a group of CTR values that include the CTR value of the matched nodes.

Thus, the CTR estimates used at the second stage of the multi-level policy may be derived from a beta-binomial model, if the beta-binomial model may be a good fit for the group or block. In particular, the CTR estimates may be taken to be the posterior mean, and sample sizes may be adjusted by adding the effective sample size parameter from the beta prior distribution. The prior distributions may be quickly estimated during the first stage, especially in the beginning when there may be small samples. This may provide better estimates of the individual pair CTRs by incorporating the taxonomies in the estimation through a hierarchical Bayesian model. If the beta-binomial model may not be a good fit, maximum likelihood estimates may be used.

Thus, the present invention may match objects belonging to hierarchies by using a multi-level bandit policy to learn an optimal matching between two feature spaces that may be organized as taxonomies. The taxonomies induce dependencies among arms of the bandit which the multi-level policy may exploit in two ways. First, it may enhance exploration with a multistage allocation scheme that matches parents followed by a match among their children. Second, it may improve estimation of rewards through shrinkage estimation in a Bayesian framework. Consequently, the multi-level bandit policy described may perform better than existing bandit policies designed for flat feature spaces.

As can be seen from the foregoing detailed description, the present invention provides an improved system and method for matching objects belonging to hierarchies. Such a system and method may efficiently be used for many online applications including content match applications for placing advertisements on web pages to maximize total revenue from user clicks. The methods described are general and may apply broadly to any learning problems with a hierarchical reward structure. For instance, in reinforcement learning, arms of a bandit may correspond to actions and payoff probabilities may correspond to reward distribution. As a result, the system and method provide significant advantages and benefits needed in contemporary computing and in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for matching objects belonging to hierarchies, comprising:
a matching engine for matching objects classified in one taxonomy with objects classified in another taxonomy by running multi-armed bandits for a plurality of levels of the taxonomies in order to maximize an overall payoff; and
a storage operably coupled to the matching engine for storing payoff probabilities for pairs of matched objects.

2. The system of claim 1 further comprising a multi-armed bandit engine operably coupled to the matching engine for running a plurality of bandits to determine payoff probabilities for matching the objects classified in the one taxonomy with the objects classified in the another taxonomy in order to maximize the overall payoff.

3. The system of claim 2 further comprising a shrinkage estimator operably coupled to the multi-armed bandit engine for performing shrinkage estimation of the payoff probabilities for matched objects from the taxonomies.

4. The system of claim 1 further comprising an index generator operably coupled to the matching engine for generating indexes for accessing multiple taxonomies and payoff probabilities for matched objects from the taxonomies.

5. A computer-readable medium having computer-executable components comprising the system of claim 1.

6. A computer-implemented method for matching objects belonging to hierarchies, comprising:
assigning a first object to a node of a first taxonomy;
matching the node of the first taxonomy with a node of a second taxonomy by running one or more multi-armed bandits for a plurality of levels of the taxonomies;
selecting a second object assigned to the node of the second taxonomy; and
outputting the second object assigned to the node of the second taxonomy.

7. The method of claim 6 wherein running one or more multi-armed bandits for a plurality of levels of the first taxonomy and the second taxonomy comprises determining a maximal payoff of matching nodes of the taxonomies.

8. The method of claim 6 further comprising:
partitioning the nodes of the first taxonomy into a first set of groups;
partitioning the nodes of the second taxonomy into a second set of groups; and
determining a maximized overall payoff of matching nodes of the taxonomies.

9. The method of claim 8 wherein determining a maximized overall payoff of matching nodes of the taxonomies comprises estimating payoff probabilities for pairs of a cross-product of the nodes from a first group of the first set of groups and the nodes from a second group of the second set of groups.

10. The method of claim 9 wherein estimating payoff probabilities for pairs of a cross-product of the nodes from a first group of the first set of groups and the nodes from a second group of the second set of groups comprises fitting a beta-binomial model to the pairs of the cross-product.

11. The method of claim 10 further comprising updating the payoff probabilities for pairs of the cross-product using beta-binomial estimates.

12. The method of claim 8 further comprising running a first bandit on the nodes from a first group of the second set of groups to select a second group of the second set of groups.

13. The method of claim 12 further comprising running a second bandit on the nodes from the second group of the second set of groups to select a node in the second group of the second set of groups.

14. The method of claim 13 wherein receiving a first object for assigning to the first taxonomy of objects comprises receiving a web page.

15. The method of claim 14 wherein selecting a second object comprises selecting an advertisement.

16. A computer-readable medium having computer-executable instructions for performing the method of claim 6.

17. A computer system for matching objects belonging to taxonomies, comprising:
means for matching a first object assigned to a node of a first taxonomy with a second object assigned to a node of a second taxonomy based on an estimate of a payoff probability; and
means for estimating the payoff probabilities for matching a third object assigned to another node of the first taxonomy with a fourth object assigned to another node of the second taxonomy.

18. The computer system of claim 17 wherein means for matching a first object assigned to a node of a first taxonomy with a second object assigned to a node of a second taxonomy based on an estimate of a payoff probability comprises means for running one or more multi-armed bandits for a plurality of levels of the first taxonomy and the second taxonomy.

19. The computer system of claim 17 wherein means for estimating the payoff probabilities for matching a third object assigned to another node of the first taxonomy with a fourth object assigned to another node of the second taxonomy comprises means for estimating payoff probabilities for pairs of a cross-product of the nodes from a first group of a first set of groups of partitioned nodes from the first taxonomy and the nodes from a second group of a second set of groups of partitioned nodes from the second taxonomy.

20. The computer system of claim 17 further comprising means for outputting an overall maximal payoff of matching nodes of the taxonomies.
